(19) United States
(12) Patent Application Publication
(10) Pub. No.: US 2013/0289329 A1
(43) Pub. Date: Oct. 31, 2013

(54) DECONTAMINATION METHOD OF CLADDING HULL WASTES GENERATED FROM SPENT NUCLEAR FUEL AND APPARATUS THEREOF

(71) Applicant: KOREA ATOMIC ENERGY RESEARCH INSTITUTE, Daejeon (KR)

(72) Inventors: Chang Hwa LEE, Daejeon (KR); Min Ku JEON, Daejeon (KR); Kweon Ho KANG, Daejeon (KR); Geun Il Park, Daejeon (KR)

(73) Assignee: Korea Atomic Energy Research Institute, Daejeon (KR)

(21) Appl. No.: 13/654,292

(22) Filed: Oct. 17, 2012

(30) Foreign Application Priority Data
Apr. 25, 2012 (KR) 10-2012-0043417

(51) Int. Cl. G21F 9/30

(52) U.S. Cl. CPC G21F 9/30
USPC 588/18; 422/184.1

(57) ABSTRACT

The present disclosure relates to a decontamination method and apparatus for cladding hull wastes of spent nuclear fuels, capable of decontaminating a small quantity of spent nuclear fuels remaining on surfaces of the cladding hull wastes and radioactive fission products penetrated into the cladding hulls through an electrochemical dissolution. The method includes inserting the cladding hull waste into an anodic basket, immersing a reference electrode and a cathodic electrode as well as the anodic basket in a molten salt, dissolving a surface of the cladding hull waste by applying a voltage or current to the anodic basket with respect to the cathodic electrode or the reference electrode, removing the anodic basket, and removing a salt remaining on the surface of the cladding hull waste.

### CROSS-REFERENCE TO RELATED APPLICATION

Pursuant to 35 U.S.C. §119(a), this application claims the benefit of earlier filing date and right of priority to Korean Application No. 10-2012-0043417, filed on Apr. 25, 2012, the contents of which is incorporated by reference herein in its entirety.

### BACKGROUND OF THE INVENTION

1. Field of the Invention

This specification relates to a decontamination method and apparatus for cladding hull wastes generated during pyroprocessing of spent nuclear fuel.

2. Background of the Invention

In general, after disassembling and shearing of nuclear fuel assembly in a pretreatment stage of a nuclear non-proliferation reprocessing technology called pyroprocessing, which is developed for efficient treatment and recycle of spent nuclear fuel, cladding hull wastes, structural component wastes and the like are generated as metallic wastes, which are left after unloading the spent nuclear fuel. Such wastes are generated as much as more than about 3.5 tons per 10-ton spent nuclear fuel. Especially, cladding hull wastes occupy about 2.5 tons of the total quantity of wastes, and the cladding hulls are all sorted as high level wastes because the spent nuclear fuel remains still within the cladding hulls or several μm of fission products are penetrated into the cladding hulls. However, if only spent nuclear fuel stuck on the cladding hull wastes and high irradiative nuclides are removed or main elements constructing the cladding hull wastes are merely extracted, disposal of the cladding hull wastes into intermediate/low level wastes or low level wastes are feasible.

For example, if cladding hulls which are occupied by zirconium (Zr) by more than 98% are treated through electrolytic refining or chlorination process, zirconium which is more than about 99% pure could be recovered. However, those processes require the zirconium (Zr) recovery, and thereby show shortcomings in the aspects of a large volume of a treatment apparatus and a long reaction time.

On the contrary, if only an extremely small quantity of spent nuclear fuel remaining still in the cladding hull wastes and the fission products penetrated into the cladding hulls are decontaminated, such shortcomings may be overcome. To this end, a chemical etching method may be used. Here, an exemplarily used chemical is an aqueous solution in which nitric acid (HNO3) and hydrofluoric acid (HF) are mixed. However, the use of the aqueous solution of the nitric acid and the hydrofluoric acid may enable separation/extraction of sensitive materials such as uranium (U) or plutonium (Pu). Accordingly, the use of such aqueous solution is inhibited in the aspect of nuclear proliferation or should be subject to strict management.

### SUMMARY OF THE INVENTION

To achieve these and other advantages and in accordance with the purpose of this specification, as embodied and broadly described herein, there is provided a decontamination method for cladding hull wastes in a method of decontaminating cladding hull wastes generated from spent nuclear fuels, the method including inserting the cladding hull waste into an anodic basket, immersing a reference electrode and an cathodic electrode as well as the anodic basket in a molten salt, dissolving a surface of the cladding hull waste by applying a voltage or current to the anodic basket with respect to cathodic electrode or the reference electrode, removing the anodic basket, and removing a salt remaining on the surface of the cladding hull waste.

In one aspect of the present disclosure, a temperature of the molten salt may be in the range of 400 to 900° C.

In one aspect of the present disclosure, the anodic basket may be made of a mesh, a porous metal layer or a ceramic.

In one aspect of the present disclosure, a material of the anodic basket may exhibit a reduction potential higher than a material of the cladding hull waste.

In one aspect of the present disclosure, the molten salt may be one of LiCl, LiCl—KCl, NaCl, NaCl—KCl, LiF—NaF and LiF—KF—NaF.

In one aspect of the present disclosure, the molten salt may further contain an initiator.

In one aspect of the present disclosure, the initiator may be one of ZrCl4, ZrF4, K2ZrF6 and LiI.

In one aspect of the present disclosure, the molten salt may further contain an additive.

In one aspect of the present disclosure, the additive may comprise fluoride and iodide.

In one aspect of the present disclosure, a voltage in the rage of −1.5 V ˜+1.0 V or a current in the range of 0.1 A/cm2˜2A/cm2, with respect to an Ag/AgCl reference electrode, may be applied depending on a material of the cladding hull waste, to dissolve the surface of the cladding hull waste.

In one aspect of the present disclosure, the dissolving of the surface of the cladding hull waste may be performed to electrochemically dissolve the surface of the cladding hull waste so as to remove or reduce spent nuclear fuel residues and fission products.

In one aspect of the present disclosure, the method may further include reducing radioactivity of the cladding hull waste by removing or reducing the spent nuclear fuel residues and fission products, and reducing a quantity and volume of high-level wastes by disposal of the cladding hull waste as an intermediate/low level or low level.

In one aspect of the present disclosure, the method may further include repetitively performing the dissolution after treatment of the cladding hull waste, so as to remove radioactive nuclides on the surface of the cladding hull waste.

In one aspect of the present disclosure, the removing of the salt may be performed to evaporate the salt under a vacuum or inactive gaseous atmosphere of 500 to 1200° C.

To achieve these and other advantages and in accordance with the purpose of this specification, as embodied and broadly described herein, there is provided a decontamination apparatus for cladding hull wastes in an apparatus for decontaminating cladding hull wastes generated from spent nuclear fuels, the apparatus including a crucible containing a molten salt, an anodic basket immersed in the molten salt and containing cladding hull wastes, and a reference electrode and a cathodic electrode immersed in the molten salt, wherein a surface of the cladding hull waste may be dissolved by applying a voltage or current to the anodic basket with respect tocathodic electrode or the reference electrode.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a flowchart showing a decontamination method for cladding hull wastes in accordance with one exemplary embodiment;

FIG. 2 is an exemplary view of a cyclic voltammogram in accordance with the exemplary embodiment;

FIG. 3 is an exemplary view of a current-time graph in accordance with the exemplary embodiment;

FIGS. 4 and 5 are sectional views of a dissolved (melted) cladding hull waste in accordance with the exemplary embodiment;

FIGS. 6 to 9 are views showing results of cyclic voltammetry performed by connecting zircaloy-4 cladding hulls, oxidized at various temperatures, to a working electrode;

FIG. 10 is a view showing a current-time graph exhibited when a specific voltage is applied after connecting the zircaloy-4 cladding hulls oxidized at the various temperatures to the anode, respectively;

FIG. 11 is a view showing results of the cyclic voltammetry before and after performing electrochemical dissolution for a cladding hull, which is oxidized at a specific temperature (for example, 500°), for a specific time with a specific voltage;

FIGS. 12 to 15 are views showing photos of surfaces of cladding hulls analyzed by means of an electron microscope after performing the experiment of FIG. 10; and

FIGS. 16 and 17 are views showing analysis results of surfaces of cladding hulls through X-ray photoelectron spectroscopy.

### DETAILED DESCRIPTION OF THE INVENTION

Technical terms used in this specification are used to merely illustrate specific embodiments, and should be understood that they are not intended to limit the present disclosure. As far as not being defined differently, all terms used herein including technical or scientific terms may have the same meaning as those generally understood by an ordinary person skilled in the art to which the present disclosure belongs, and should not be construed in an excessively comprehensive meaning or an excessively restricted meaning. In addition, if a technical term used in the description of the present disclosure is an erroneous term that fails to clearly express the idea of the present disclosure, it should be replaced by a technical term that can be properly understood by the skilled person in the art. In addition, general terms used in the description of the present disclosure should be construed according to definitions in dictionaries or according to its front or rear context, and should not be construed to have an excessively restrained meaning.

A singular representation may include a plural representation as far as it represents a definitely different meaning from the context. Terms ‘include’ or ‘has’ used herein should be understood that they are intended to indicate an existence of several components or several steps, disclosed in the specification, and it may also be understood that part of the components or steps may not be included or additional components or steps may further be included.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

Embodiments of the present invention will be described below in detail with reference to the accompanying drawings, where those components are rendered the same reference number that are the same or are in correspondence, regardless of the figure number, and redundant explanations are omitted.

In describing the present invention, if a detailed explanation for a related known function or construction is considered to unnecessarily divert the gist of the present invention, such explanation has been omitted but would be understood by those skilled in the art. The accompanying drawings are used to help easily understood the technical idea of the present invention and it should be understood that the idea of the present invention is not limited by the accompanying drawings.

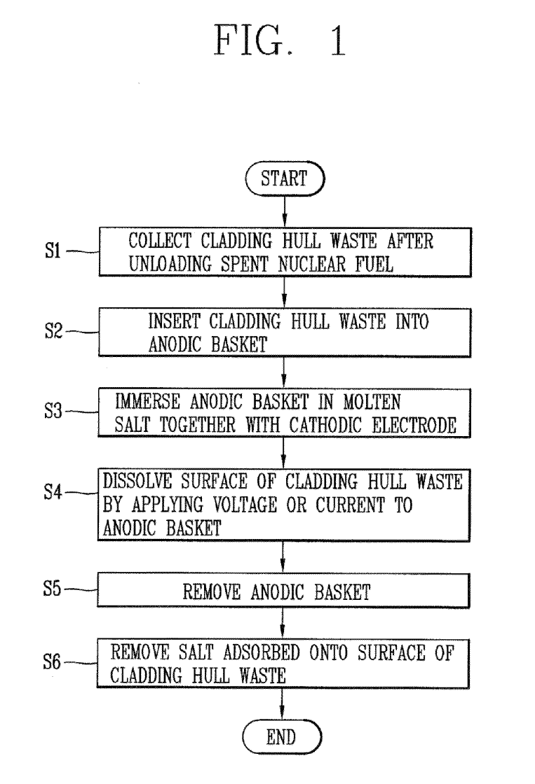

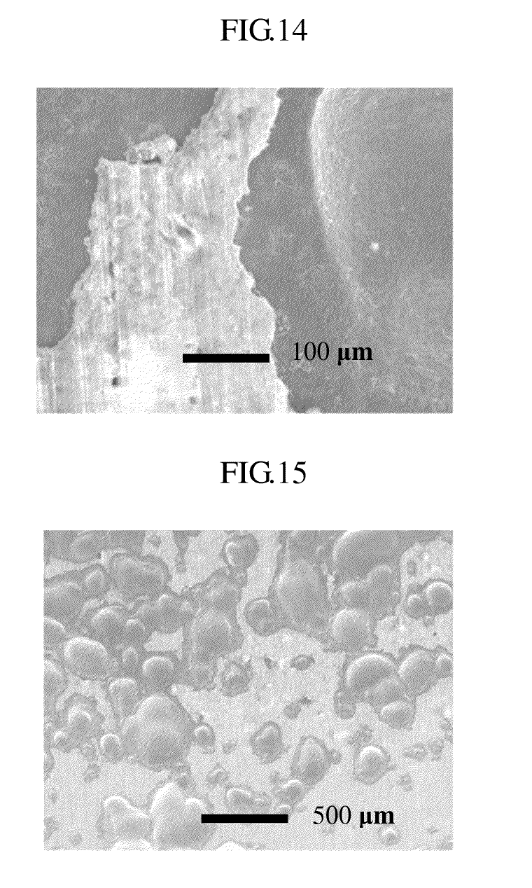

Hereinafter, description will be given of a method for treating cladding hull wastes in accordance with an exemplary embodiment with reference to FIGS. 1 to 17. Also, detailed explanation for a related known function or construction, which is considered to unnecessarily divert the gist of the present invention, such explanation is omitted.

A decontamination apparatus for cladding hull wastes in accordance with an exemplary embodiment may include a crucible containing molten salt, an anodic basket immersed in the molten salt and containing cladding hull wastes, a reference electrode and a cathodic electrode immersed in the molten salt, and a power supply unit to apply a voltage or current to the electrodes. Surfaces of the cladding hull wastes may be dissolved as the voltage or current is applied to the anodic basket with respect to the cathodic electrode or the reference electrode.

FIG. 1 is a flowchart illustrating a decontamination method for cladding hull wastes in accordance with one exemplary embodiment.

First, to remove spent nuclear fuel residues remaining on a surface of a cladding hull waste and fission products through electrochemical dissolution, the cladding hull (cladding, cladding tube, cladding hull waste) is collected after unloading (extracting) the spent nuclear fuel within the cladding hull (S1).

The cladding hull is inserted into a basket made of a metal (for example, stainless steel) (S2). The cladding hull inserted into the basket may be in plurality.

After inserting the cladding hull into the metallic basket (for example, stainless steel basket), the basket is connected to a anode.

The basket connected to the anode (i.e., anodic basket) and a cathodic electrode are immersed into a molten salt (S3). A reference electrode may be added into to the molten salt if necessary. The anodic basket may be made of a mesh, a porous metal film or a ceramic to allow dissolved materials to be discharged therethrough with maintaining conductivity in a contact state with the cladding hull waste. The molten salt may be filled in a crucible (not shown).

The cathodic electrode may be implemented by using molybdenum (Mo), tungsten (W), iron (Fe), nickel (Ni) and the like or alloy thereof, and the reference electrode may be implemented by using Ag/Ag+, Ni/Ni2+, Na/Na+, Al/Al3+, Pt/Pt2+ and the like.

After immersing the anodic basket and the cathodic electrode in the molten salt, a preset voltage or current is applied to the anode, dissolving the surface of the cladding hull waste (S4). That is, to electrochemically dissolve the cladding hull waste, a voltage or current appropriate to oxidize main components of the cladding is applied to the cathodic basket. For example, a voltage in the range of 0.1V to −1.0V with respect to Ag/AgCl reference electrode is applied to zircaloy or zirlo containing zirconium, to allow the zirconium (Zr) to be oxidized and dissolved to Zr2+ or Zr4+. That is, for treatment of the zirconium-based cladding hull such as the zircaloy or zirlo, a positive potential rather than a balancing reduction potential of the zirconium is applied to induce oxidization and dissolution of the zirconium on the surface of the cladding hull waste. The current and voltage may change into a positive direction to increase the oxidation speed.

Therefore, the spent nuclear fuel residues and fission products may be removed or reduced by dissolving the surface of the cladding hull waste through the electrochemical dissolution.

Also, with the removal or reduction of the spent nuclear fuel residues and fission products, radioactivity of the cladding hull waste may be reduced and the cladding hull waste may be disposed as an intermediate/low level or a low level, resulting in decreasing a quantity and volume of high-level wastes. With the reduction of radioactivity of the cladding hull wastes by virtue of the removal or reduction of the spent nuclear fuel residues and fission products, the cladding hull wastes may be recycled as an additive or a nuclear reactor component or container upon disposal of nuclear fuel and high-level radioactive wastes of Sodium-cooled Fast Reactor (SFR).

As the immersing solvent, a molten salt such as LiCl, LiCl—KCl, NaCl, NaCl—KCl, LiF—NaF, LiF—KF—NaF, or the like may be used.

For more effective dissolution of the surface of the cladding hull waste, an initiator such as ZrCl4, ZrF4, K2ZrF6, LiI or the like may further be contained in the molten salt.

Fluoride such as NaF, KF, LiF or the like and iodide such as LiI may further be contained in the molten salt (for example, chloride-based molten salt). That is, the further addition of the initiator and/or the additive into the molten salt may result in an effective dissolution of the surface of the cladding hull waste.

After removing the treated anodic basket (S5), the salt remaining on the surface of the cladding hull waste is removed (S6). For example, after taking the cladding treated by the electrochemical dissolution out of the molten salt, the salt is evaporated in a vacuum or inactive gaseous atmosphere of 500° C. to 1200° C. The salt absorbed onto the surface of the cladding hull waste is thus removed.

A material of the anodic basket may preferably have a reduction potential higher than a main material of the cladding hull such that the anodic basket cannot be affected by the electrochemical dissolution. That is, the basket may be made of a metal whose reduction potential is higher than the main component of the cladding hull. For example, if the cladding hull is made of zirconium-containing zircaloy or zirlo, the basket may be made of molybdenum (Mo), tungsten (W), iron (Fe), nickel (Ni) and the like or alloy thereof.

After disposal of the cladding hull waste, the second or third dissolution may be repeatedly performed, if necessary, to remove radioactive nuclides on the surface of the cladding hull waste. For example, when the spent nuclear fuel residues or fission products are removed through the electrochemical dissolution, the dissolution time may extend or the second or third electrochemical dissolution may be performed in the molten salt, enhancing decontamination effect.

An experiment may be performed within a glove box filled with inactive gas during the disposal of the cladding hull waste, thereby adjusting a concentration of oxygen and moisture to several to several tens of ppm.

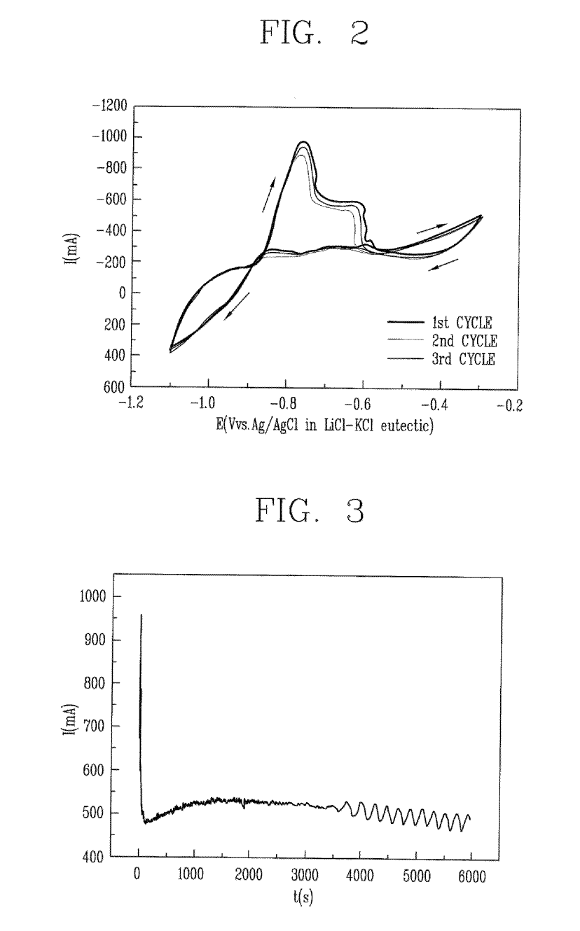

FIG. 2 is an exemplary view illustrating a cyclic voltammogram in accordance with the exemplary embodiment, which is a cyclic voltammogram measured by changing a potential from −0.3 V to −1.1 V using a zircaloy-4 cladding wound with stainless steel wires as a working electrode, a stainless steel wire counter electrode, and Ag/AgCl reference electrode (i.e., results of cyclic voltammetry for three cycles). Here, the solvent may be a molten salt, which is obtained by adding 4 percent by weight of ZrCl4 into LiCl—KCl eutectic salt and heating it at about 500° C. (or 400˜900° C.). It can be noticed that the zirconium is oxidized at a positive potential and reduced at a negative potential based on about −0.9 V. Especially, a peak that a metallic zirconium is oxidized into a divalent zirconium is observed near −0.78 V.

To dissolve the surface of the cladding hull waste, a voltage in the rage of −1.5 V ˜+1.0 V or a current in the range of 0.1 A/cm2˜2A/cm2, with respect to Ag/AgCl reference electrode, may be applied depending on a main material of the cladding hull waste.

FIG. 3 is an exemplary view illustrating a current-time graph in accordance with the exemplary embodiment, which shows a current-time graph when connecting the zircaloy-4 cladding to an anode using a metallic wire (e.g., stainless steel wire), and applying a preset voltage of −0.78 V, at which the oxidization peak of the zirconium is observed based on the Ag/AgCl electrode, to the zircaloy-4 cladding, in the same molten salt for 6,000 seconds. The occurrence of the zirconium oxidization may be confirmed in terms of the presence of a current in the amount of about 500˜550 mA.

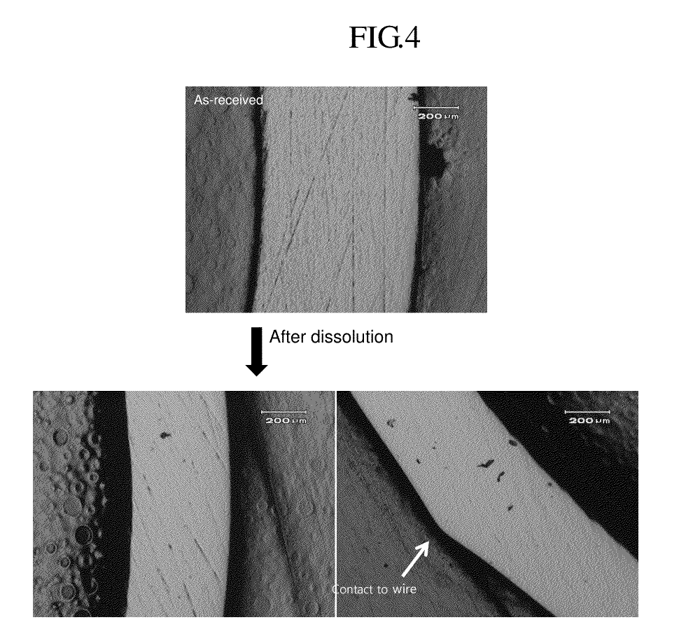

FIGS. 4 and 5 are sectional views of a dissolved surface of a cladding hull waste in accordance with the exemplary embodiment.

As shown in FIG. 4, a section of the surface of zircaloy-4 cladding hull after being dissolved for 6,000 seconds at the −0.78 V may be checked by means of an optical microscope. The surface dissolution may be exhibited in the aspect that that a thickness of the cladding hull waste is about 700 μm prior to oxidization and about 450 μm after oxidization. Also, it can be noticed that a contact portion between the cladding hull and the stainless steel wire is less dissolved.

FIG. 5 shows component analysis results at a contact portion and a non-contact portion between the cladding hull waste and the stainless steel wire, which shows analysis results obtained by use of Scanning Electron Microscopy-Energy Dispersive X-ray (SEM-EDX). This shows that there is no big difference in thickness of an oxide layer of the surface of the cladding hull waste.

During decladding for unloading the spent nuclear fuel in the pretreatment stage of the pyroprocessing, the cladding hull waste may be oxidized under air or oxygen atmosphere of about 400˜700° C. For zircaloy-4, a zirconium oxide layer may have a thickness in the range of several to several tens of μm according to temperature and time. This may affect the electrochemical surface dissolution. Hence, the same experiment has been performed using the oxidized cladding hull waste.

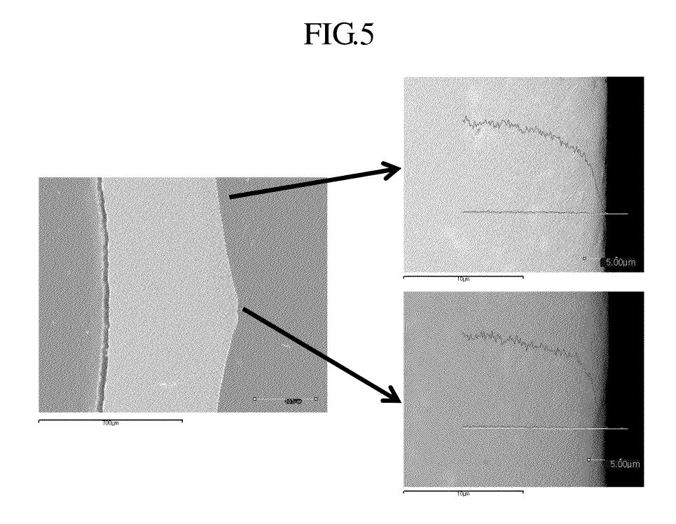

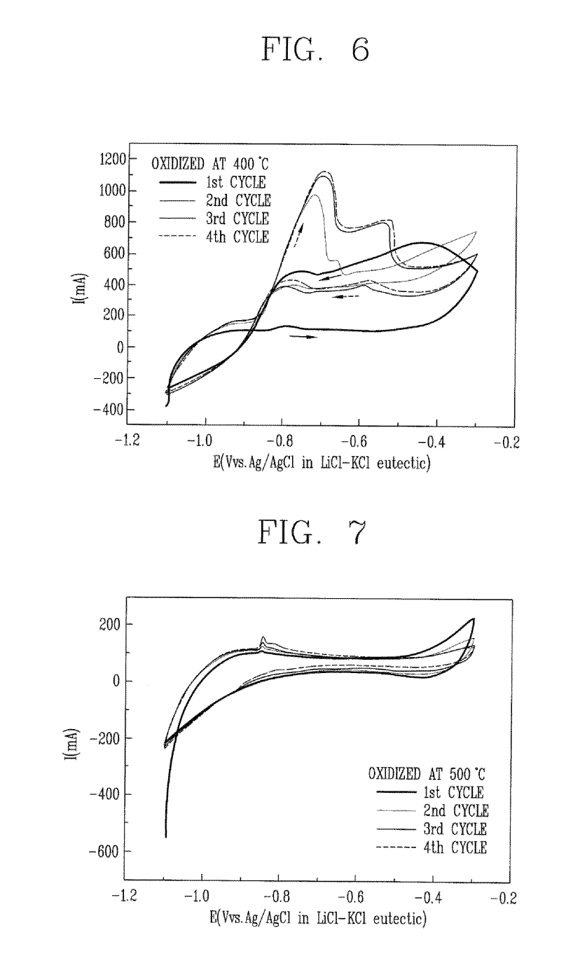

FIGS. 6 to 9 are views showing results of cyclic voltammetry performed for zircaloy-4 cladding hulls oxidized at various temperatures as a working electrode. These views show the results of the cyclic voltammetry performed in a voltage range of −0.3 V˜−1.1 V within the same molten salt by using the zircaloy-4 cladding hulls, which have been oxidized for 5 hours under an air atmosphere of 400° C. to 600° C., as a working electrode.

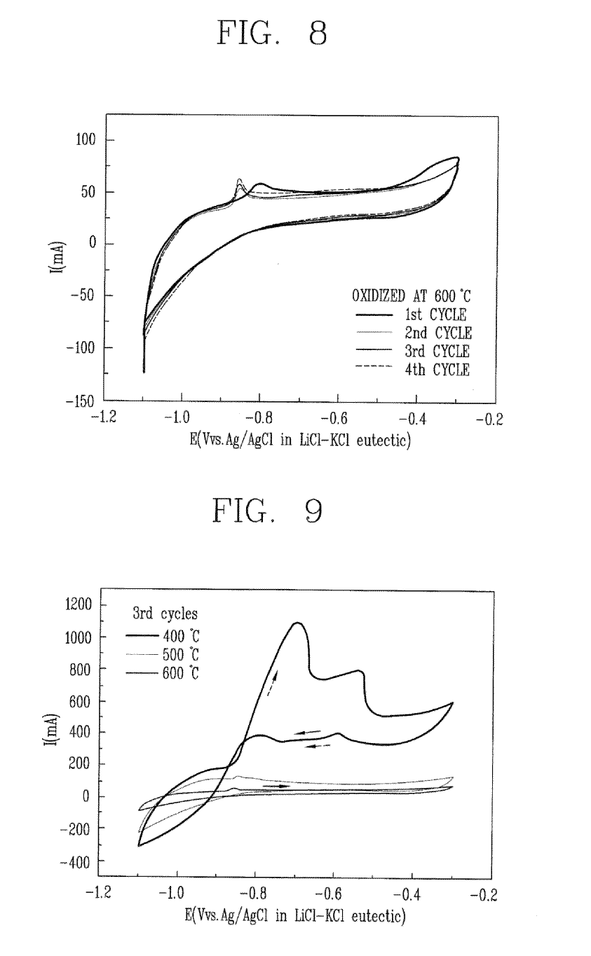

The results for the cladding hulls oxidized at 400° C., 500° C. and 600° C. are shown in FIG. 6, FIG. 7 and FIG. 8, respectively. FIG. 9 shows a comprehensive result of the third cycle from each result. For the cladding hull which has the zirconium of about 0.5 μm thick and has been oxidized at 400° C., it may be noticed that the oxidization peak is not great in the first cycle but increases from the second cycle and the current is saturated in the third cycle. This may be understood as the zirconium oxide layer formed on the surface of the cladding hull has been removed during the cyclic voltammetry within the molten salt.

On the contrary, for the cladding hulls oxidized at 500° C. and 600° C., the oxide layers of the surfaces of the cladding hulls are about 1.3 μm and 4.5 μm thick, respectively. Referring to FIGS. 7 and 8, they rarely exhibit the oxidization peak, as compared with the cladding oxidized at 400° C. (FIG. 9), in the cyclic voltammetry.

FIG. 10 is a view illustrating a current-time graph exhibited when a specific voltage is applied after connecting the zircaloy-4 cladding hulls oxidized at the various temperatures to the anode, respectively.

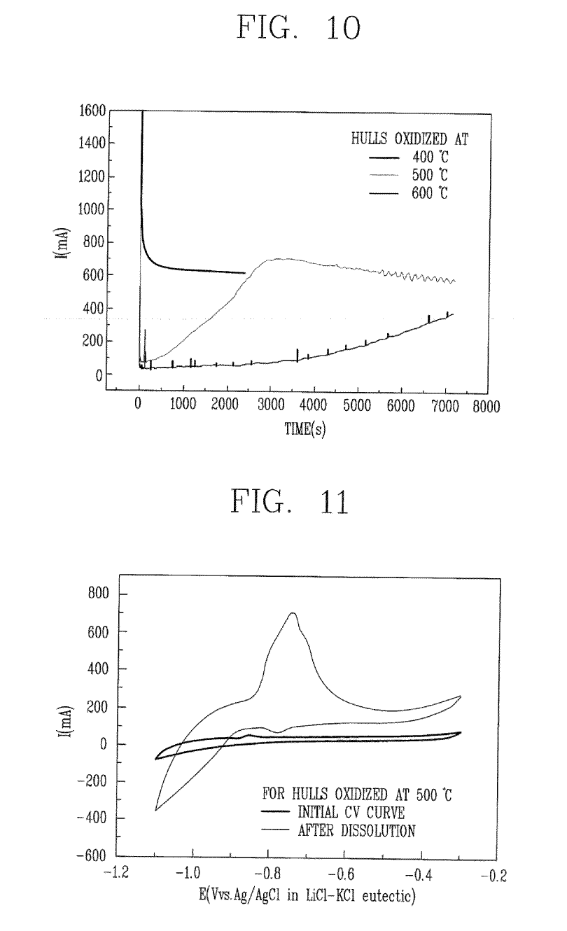

FIG. 11 is a view illustrating results of the cyclic voltammetry before and after performing electrochemical dissolution for a cladding hull, which has been oxidized at a specific temperature (for example, 500°), for a specific time with a specific voltage.

For example, when the zircaloy-4 cladding hulls oxidized at 400° C., 500° C. and 600° C., respectively, for 5 hours, are equally connected to the electrodes and immersed into the same molten salt, and a voltage of −0.78 V is applied to the corresponding cladding hulls, the current-time graphs are represented as shown in FIGS. 10 and 11. As can be noticed in the graphs, the dissolution of the cladding oxidized at 400° C. is started from the beginning, while the dissolution of the cladding oxidized at 500° C. is inhibited at the beginning but the dissolution speed is getting faster to be similar to the dissolution speed of the cladding oxidized at 400° C. after about 2,500 seconds. Especially, it can be exhibited that the initial inhibition time of the dissolution of the cladding hull oxidized at 600° C. is much longer than the others. According to the measurement result of the cyclic voltammogram after dissolving the surface of the cladding oxidized at 500° C. for 2 hours, it can also be seen that the oxidization peak is clearly exhibited as compared to the cyclic voltammogram prior to dissolution (see FIG. 11).

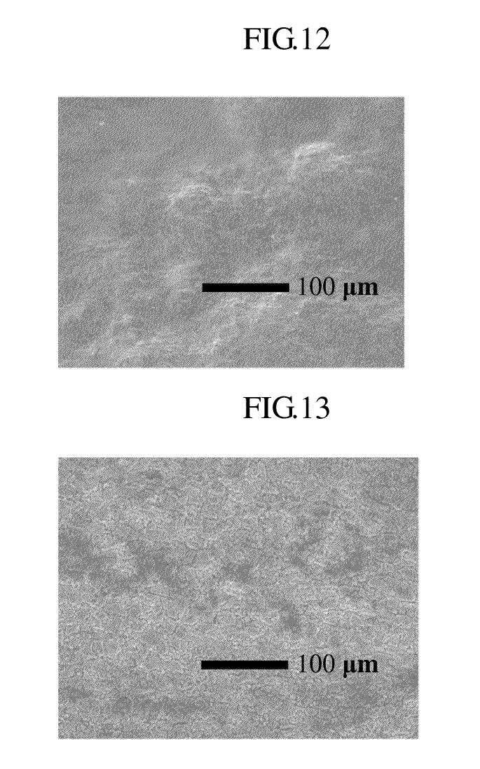

FIGS. 12 to 15 are views illustrating photos of surfaces of cladding hulls analyzed by means of an electron microscope after performing the experiment of FIG. 10. Here, the surfaces of the cladding hulls, each of which has been oxidized for 5 hours at 400° C., 500° C. and 600° C., are electrochemically dissolved at a voltage of −0.78V. The respective results are shown in FIGS. 12, FIG. 13 and FIGS. 14 and 16. Here, the dissolution has been performed for 40 minutes with respect to the cladding hull oxidized at 400° C., and for 2 hours with respect to the cladding hulls oxidized at 500° C. and 600° C.

Referring to FIG. 12, for the cladding hull oxidized at 400° C., even if the dissolution therefor was performed for 40 minutes, the dissolution speed was so fast from the beginning. Accordingly, the corresponding cladding hull exhibited a very rough surface, as compared to the cladding hull, which was oxidized at 500° C. and dissolved for 2 hours (FIG. 13). On the other hands, the cladding hull oxidized at 600° C. still partially had the oxide layer, and this was likely to serve to inhibit the dissolution of the cladding hull.

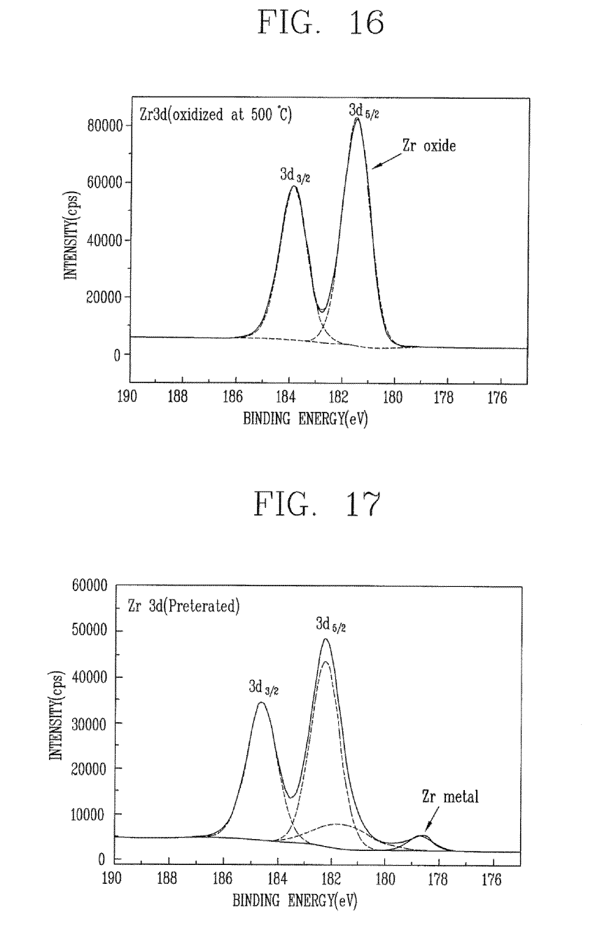

In order to check whether or not the zirconium oxide layer on the surface of the cladding within the molten salt of high temperature is removed electrochemically, a piece (fragment) of the cladding hull oxidized at 500° C. for 5 hours was immersed into a molten salt, which contained LiCl—KCl eutectic salt and 4 percent by weight of ZrCl4, at 500° C. for 1 hour. Afterwards, the surface of the cladding was analyzed by means of X-ray Photoelectron Spectroscopy (XPS). The results were shown in FIGS. 16 and 17.

FIGS. 16 and 17 are views illustrating analysis results of surfaces of cladding hulls through X-ray photoelectron spectroscopy, which show the analysis results through the XPS for a surface of the zircaloy-4 cladding oxidized at 500° C. for 5 hours and a surface of the corresponding cladding after immersing the cladding into the molten salt of 500° C. for 1 hour without an application of voltage or current.

As shown in FIGS. 16 and 17, Zr 3d peak, which corresponds to a metallic zirconium which was not exhibited prior to immersing the cladding into the molten salt, has been observed. Namely, the zirconium oxide layer is in the form of thin ZrO or Zr2O3 so as to be removed due to formation of a third material or a new phase within the molten salt, or likely to be removed together when a lower Zr layer is removed through a defective portion of the Zr oxide layer.

As illustrated in the exemplary embodiment, as the oxidation temperature increases during decladding of the spent nuclear fuel, the thickness of the oxide layer of the cladding hull increases. This may extend a time taken to dissolve the surface of the cladding hull. However, it can be observed that the surface of the cladding hull oxidized at about 500° C., which is an optimum decladding condition, is easily dissolved through the electrochemical dissolution.

As described above, in accordance with the decontamination method and apparatus for the cladding hull waste according to the exemplary embodiments, the cladding hull waste may be decontaminated in a molten salt through an electrochemical dissolution. It may make it possible to effectively remove residual spent nuclear fuel (products) remaining still on a surface of the cladding hull waste or fission products contained in an oxide layer in a lift-off manner.

In accordance with the decontamination method and apparatus for the cladding hull waste according to the exemplary embodiments, a deep dissolution of the surface of the cladding hull may be enabled, resulting in decontamination of fission products penetrated into the surface of the metallic cladding hull.

In accordance with the decontamination method and apparatus for the cladding hull waste according to the exemplary embodiments, since the residual spent nuclear fuel or fission products remain in the molten salt together with rare earth elements, jewelries and various nuclides, they may be recollected or treated in a high nuclear proliferation-resistant manner upon following treatment or decontamination.

In accordance with the decontamination method and apparatus for the cladding hull waste according to the exemplary embodiments, a process time may be more reduced than electrolytic refining or chlorination method of extracting and collecting main components of cladding hull wastes, and an additional process of treating recollected components may also be reduced, resulting in reduction of process costs.

In accordance with the decontamination method and apparatus for the cladding hull waste according to the exemplary embodiments, a quantity of high level wastes can be remarkably reduced by treatment of cladding hull wastes and the treated cladding hull wastes can be recycled, which may arise an additional economic gain.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A method of decontaminating cladding hull wastes generated from spent nuclear fuels, the method comprising:
inserting the cladding hull waste into an anodic basket;
immersing a reference electrode and a cathodic electrode as well as the anodic basket in a molten salt;
dissolving a surface of the cladding hull waste by applying a voltage or current to the anodic basket with respect to the anodic electrode or the reference electrode;
removing the anodic basket; and
removing a salt remaining on the surface of the cladding hull waste.

2. The method of claim 1, wherein a temperature of the molten salt is in the range of 400 to 900° C.

3. The method of claim 1, wherein the anodic basket is made of a mesh, a porous metal layer or a ceramic.

4. The method of claim 1, wherein a material of the anodic basket exhibits a reduction potential higher than a material of the cladding hull waste.

5. The method of claim 1, wherein the molten salt is one of LiCl, LiCl—KCl, NaCl, NaCl—KCl, LiF—NaF and LiF—KF—NaF.

6. The method of claim 1, wherein the molten salt further contains an initiator.

7. The method of claim 6, wherein the initiator is one of ZrCl4, ZrF4, K2ZrF6 and LiI.

8. The method of claim 7, wherein the molten salt further contains an additive.

9. The method of claim 8, wherein the additive is fluoride and iodide.

10. The method of claim 1, wherein a voltage in the rage of −1.5 V ˜+1.0 V or a current in the range of 0.1 A/cm2˜2A/cm2, with respect to an Ag/AgCl reference electrode, is applied depending on a material of the cladding hull waste, to dissolve the surface of the cladding hull waste.

11. The method of claim 10, wherein the dissolving of the surface of the cladding hull waste is performed to electrochemically dissolve the surface of the cladding hull waste so as to remove or reduce spent nuclear fuel residues and fission products.

12. The method of claim 11, further comprising reducing radioactivity of the cladding hull waste by removing or reducing the spent nuclear fuel residues and fission products, and reducing a quantity and volume of high-level wastes by disposal of the cladding hull waste as an intermediate/low level or low level.

13. The method of claim 1, further comprising repetitively performing the dissolution after treatment of the cladding hull waste, so as to remove radioactive nuclides on the surface of the cladding hull waste.

14. The method of claim 1, wherein the removing of the salt is performed to evaporate the salt under a vacuum or inactive gaseous atmosphere of 500 to 1200° C.

15. A decontamination apparatus for cladding hull wastes in an apparatus for decontaminating cladding hull wastes of spent nuclear fuels, the apparatus comprising:
a crucible containing a molten salt,
an anodic basket immersed in the molten salt and containing cladding hull wastes; and
a reference electrode and a cathodic electrode immersed in the molten salt,
wherein a surface of the cladding hull waste is dissolved by applying a voltage or current to the anodic basket with respect to the cathodic electrode or the reference electrode.
